(19) United States
(12) Patent Application Publication
(10) Pub. No.: US 2021/0150551 A1
(43) Pub. Date: May 20, 2021

(54) CREATING AND PUBLISHING USER SEGMENTS TO CROSS-CHANNEL ACTIVATION TARGETS

(71) Applicant: Salesforce.com, inc., San Francisco, CA (US)

(72) Inventors: Vineeth Anand Nair, Fremont, CA (US); Aaron Popelka, San Francisco, CA (US); Sridhar Prathivadi, Dublin, CA (US); Jason Day, Fortville, IN (US); Gabrielle Tao, San Mateo, CA (US); Sarah Flamion, Newburgh, IN (US); Ashok Shivarudraiah, Fremont, CA (US)

(21) Appl. No.: 16/821,068

(22) Filed: Mar. 17, 2020

Related U.S. Application Data
(60) Provisional application No. 62/937,197, filed on Nov. 18, 2019.

(51) Int. Cl. G06Q 30/02; G06F 21/62; G06F 16/9536

(52) U.S. Cl. CPC G06Q 30/0204; G06F 16/9536; G06Q 30/0201; G06F 21/6245

(57) ABSTRACT

Methods, systems, and devices supporting creating and publishing user segments across data accessing units are described. In some database systems, data for a tenant is stored across multiple siloed data accessing units (e.g., data structures that may not share particular data objects). To efficiently grant users in multiple data accessing units access to a user segment, the system may implement activation targets. For a segment of user identifiers, a user may input a set of data accessing units for an activation target, and a server may create the activation target. The user may indicate to publish the segment to the activation target. The server may store the segment of user identifiers (e.g., along with indicated attributes, contact points, or both) at the database system such that the segment is accessible to tenant users of the data accessing units specified in the activation target, but is inaccessible to other users.

### CROSS REFERENCES

The present Application for Patent claims priority to U.S. Provisional Patent Application No. 62/937,197 by Nair et al., entitled “CREATING AND PUBLISHING USER SEGMENTS TO CROSS-CHANNEL ACTIVATION TARGETS,” filed Nov. 18, 2019, which is assigned to the assignee hereof and expressly incorporated by reference herein.

### FIELD OF TECHNOLOGY

The present disclosure relates generally to database systems and data processing, and more specifically to creating and publishing user segments to cross-channel activation targets.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

Some cloud platforms or other data management systems may implement data accessing units (e.g., business units (BUs)) for organizing user access to stored data. For example, a user associated with an organization may be assigned to one BU and may not be able to access, modify, or view data stored in a different BU (e.g., even for the same organization). Based on an organization's structure, there may be hierarchical guidelines, security constraints, budget constraints, or similar constraints that limit sharing data across BUs. As such, an organization's data in one BU may be siloed off from the organization's data in another BU. This may lead to inefficient data management, repetitive data processing tasks that lead to significant processing overhead, inaccurate data analysis across BUs, or any combination of these shortcomings.

### BRIEF DESCRIPTION OF THE DRAWINGS

FIGS. 1 and 2 illustrate examples of systems that support creating and publishing user segments to cross-channel activation targets in accordance with aspects of the present disclosure.

FIG. 3 illustrates an example of a user segment publication system that supports creating and publishing user segments to cross-channel activation targets in accordance with aspects of the present disclosure.

FIG. 4 illustrates an example of a user device including a user interface that supports creating and publishing user segments to cross-channel activation targets in accordance with aspects of the present disclosure.

FIG. 5 illustrates an example of a user interface sequence that supports creating and publishing user segments to cross-channel activation targets in accordance with aspects of the present disclosure.

FIG. 6 shows an example of a process flow that supports creating and publishing user segments to cross-channel activation targets in accordance with aspects of the present disclosure.

FIG. 7 shows a block diagram of an apparatus that supports creating and publishing user segments to cross-channel activation targets in accordance with aspects of the present disclosure.

FIG. 8 shows a block diagram of an activation target manager that supports creating and publishing user segments to cross-channel activation targets in accordance with aspects of the present disclosure.

FIG. 9 shows a diagram of a system including a device that supports creating and publishing user segments to cross-channel activation targets in accordance with aspects of the present disclosure.

FIG. 10 shows a flowchart illustrating a method that supports creating and publishing user segments to cross-channel activation targets in accordance with aspects of the present disclosure.

### DETAILED DESCRIPTION

Some data management systems may store data for an organization (e.g., a business, a company, etc.) in multiple data accessing units (e.g., business units (BUs)). For example, for a single tenant, a multi-tenant database system may store multiple data accessing units segregating data storage and processing between different groups within the tenant. A BU may control access to data, the sharing of information in the context of a group, product, or service, or a combination thereof. For example, an organization may include multiple divisions, brands, or geographic regions, and a BU may be created for each division, brand, or geographic region so that users within a BU can access content that is associated with the BU. In some cases, a BU may impose policies or guidelines that limit data sharing or publishing across BUs (e.g., across independent organizational units). For example, a BU may be associated with a geographic region, and the geographic region may impose data protection policies (e.g., the European Union's general data protection regulation (GDPR)). In some cases, organizational groups (e.g., BUs) may increase the difficulty of reaching users (e.g., via user segments), result in an increased processing overhead associated with reaching users, or both.

User segments may be used to target or otherwise reach user groups. In some examples, a cloud application may support a customer data platform (CDP) for managing user segments. A CDP may include one or more applications and may support functionality to ingest data from multiple sources, parse and analyze the data to define and build segments of users based on attributes, activate the segments to further track and analyze users (e.g., customers) and their associated data (e.g., communication data, spending data, etc.) to gain insights regarding a group of users, and/or communicate with the group of users (e.g., based on a marketing strategy). Each user segment may be associated with or relevant to a particular channel in an organization (e.g., corresponding to a particular BU). In some cases, a user segment may be relevant to multiple BUs in order to reach users within different contexts. Additionally or alternatively, a user segment may be relevant to multiple different BUs to support multiple forms of user contact. This may lead to repetitive data processing to create user segments within each relevant BU. Additionally or alternatively, a user manager may utilize a user segment to send messages to and/or reach a user group, and the user manager may lack the ability to personalize the message sent to users of a particular user group.

To support publishing a user segment with customizable personalization across multiple data accessing units (e.g., BUs), a system may implement activation targets for publishing user segments. A user associated with an organization may create an activation target based on one or more data accessing units. For example, the system may determine a user segment generated based on a segmentation rule. This user segment may be applicable or relevant to more than one data accessing unit of the organization. In some examples, the user may indicate one or more data accessing units for a tenant, and the activation target may be created based on the indicated one or more data accessing units. Each data accessing unit for the tenant may include a subset of tenant users for the tenant and one or more data accessing unit-specific rules for data access. For example, the users for a particular data accessing unit may access the tenant's data according to the data accessing unit-specific rules for that particular data accessing unit. This may allow the users to access a subset of the tenant's data while restricting the users from accessing other data for the tenant (e.g., data not relevant to the users, data with higher security measures, etc.).

In some cases, a data accessing unit-specific rule may be based on user preferences, a data management policy, a security policy, a regulation, a law, or the like. In some examples, an organization may provide services in multiple regions (e.g., geographic regions, legal jurisdictions, etc.) subject to different legal stipulations, and the data accessing unit-specific rule may be based on the legal stipulations relevant to the region associated with the data accessing unit. In some additional or alternative examples, an organization may serve users that require, desire, or prefer varying data access privileges. For example, a first group of users may be associated with read and write privileges, while a second group of user may be associated with read-only privileges, and the data accessing unit-specific rule may be based on the privileges associated with the first user group and/or the second user group. The use of activation targets may improve data security by upholding the rules associated with different data accessing units without performing multiple activations for the same user segment.

The user may select to publish a user segment to the created activation target (e.g., based on a second user input). The segment may be stored in a database system based on the second user input, where the stored segment is accessible to tenant users of the one or more data accessing units included in the activation target but may be inaccessible to other tenant users. In some cases, publishing a user segment to multiple data accessing units (e.g., BUs) may improve user productivity, mitigate budgetary constraints, and improve organization effectiveness. Additionally, the activation target may be reused for multiple user segments, supporting efficient repeatability of publishing to a same set of data accessing units (e.g., related data accessing units commonly interested in similar user segments). The activation targets may support data lineage (e.g., tracking and analysis of the originating sources of user data), customizable data attributes (e.g., where different attributes may be stored for a single generated segment of users at different data accessing units), or both. In some cases, quality metrics for the user segments may be defined, recorded, analyzed, or some combination thereof at the data accessing unit-level.

Aspects of the disclosure are initially described in the context of an environment supporting an on-demand database service. Additional aspects are described with reference to systems, procedures, and user interfaces supporting activation targets for user segments. Aspects of the disclosure are further illustrated by and described with reference to apparatus diagrams, system diagrams, and flowcharts that relate to creating and publishing user segments to cross-channel activation targets.

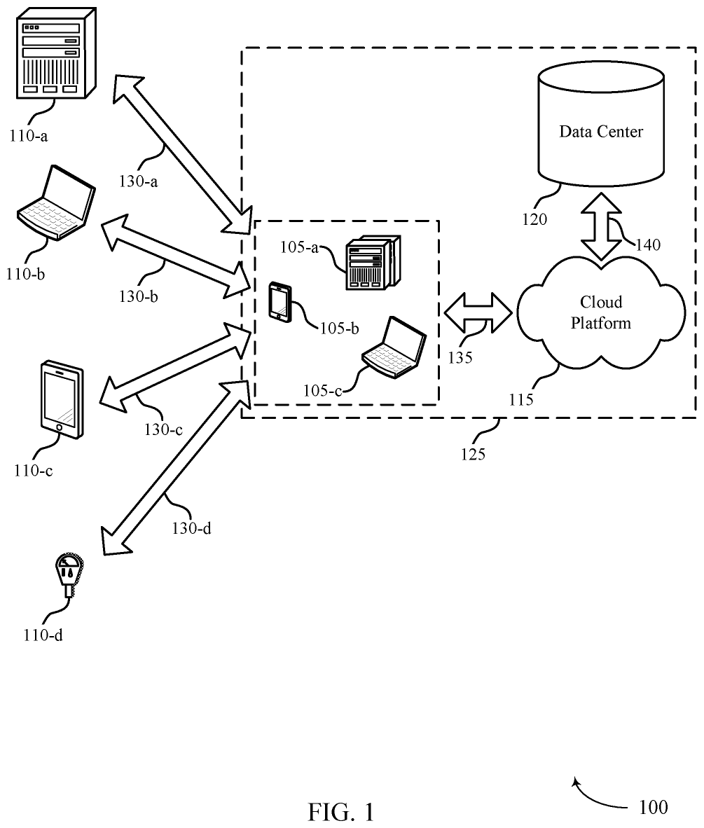

FIG. 1 illustrates an example of a system 100 that supports creating and publishing user segments to cross-channel activation targets in accordance with aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135 and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

Data center 120 may support BUs. For example, the data center 120 may be a multi-tenant database system. Accordingly, the data center 120 may restrict access to data such that users associated with a particular tenant may access that tenant's data but may not access other tenants' data. In some cases, data center 120 may support further granularity of data access restrictions. For example, within a tenant, different users may correspond to different sub-groups of the tenant (e.g., based on an organizational hierarchy). Data center 120 may organize data into data accessing units (e.g., BUs), where the users of a tenant associated with a particular data accessing unit may access data for that tenant according to the data accessing rules specific to that data accessing unit. In some systems, a tenant may implement rules against sharing data (e.g., any data, particular types of data, etc.) across data accessing units (e.g., for improved security, policy compliance, etc.). However, these rules may restrict the applicability of data analytics and user identifications across data accessing units (e.g., BUs) within a tenant's organization.

Some other systems may support multiple BUs but may fail to provide integration across the multiple BUs. For example, a BU may limit the sharing of data, provide strict guidelines, or impose budgetary constraints and thereby fail to provide integration across BUs. In some systems, a user segment may be associated with a BU, and the user segment may be re-created in additional BUs. Creating a user segment may be time consuming (e.g., time consuming for a user to create) and resource intensive (e.g., rely on significant computational resources), and re-creating a user segment for multiple BUs may degrade system performance. Some systems may additionally or alternatively fail to support personalization in messages and/or fail to measure the effectiveness of a publication or activation strategy. Multiple BUs may increase the difficulty of sharing and/or collaborating across organizational groups.

In contrast, the system 100 may implement the creation and publication of user segments to cross-channel activation targets, supporting integration of user segments across multiple BUs. This may allow for efficient data analytics on a same user segment in multiple data accessing units while maintaining the proper data isolation between the data accessing units for a tenant. Additionally, using an activation target for publishing a user segment may reduce a processing overhead associated with storing a user segment in multiple BUs. System 100 may additionally or alternatively support message personalization and/or effective analysis of a publication or activation strategy across BUs.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

The system 100 may ingest data (e.g., user-specific information from one or more data sources), build one or more user segments, and publish the segments to one or more endpoints (e.g., one or more data accessing units). An activation target may define a set of bundled data accessing units, a set of bundled attributes for generating a user segment (e.g., where the attributes may be split between different data accessing units via separate data streams when publishing the user segment), or both.

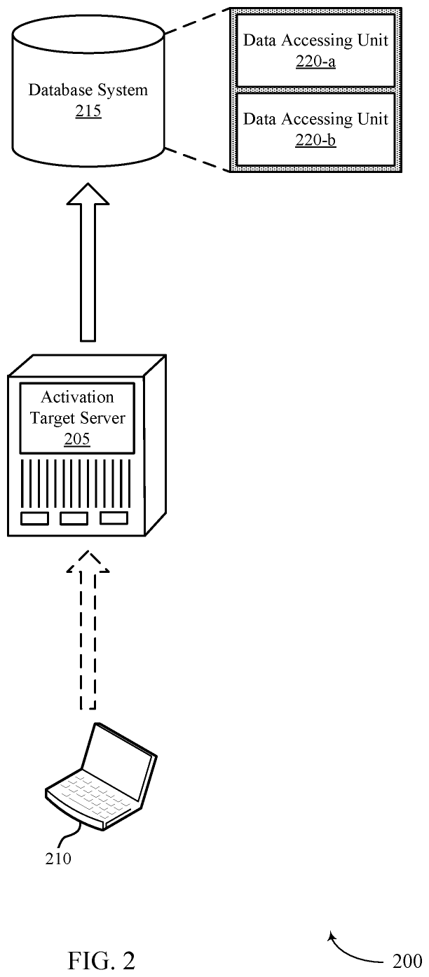

FIG. 2 illustrates an example of a system 200 that supports creating and publishing user segments to cross-channel activation targets in accordance with aspects of the present disclosure. The system 200 includes an activation target server 205, a user device 210, and a database system 215. The system 200 may implement aspects of a system 100 as described with reference to FIG. 1. For example, an activation target server 205 and/or a database system 215 may be examples or components of a data center 120. The activation target server 205 may be an example of an application server, a database server, a cloud-based server, a server cluster, a virtual machine, a container, or any other system or device that supports data processing. A user device 210 may implement aspects of subsystem 125 or cloud client 105 as described with reference to FIG. 1.

The database system 215 may store data for a tenant across multiple data accessing units 220. For example, a single tenant (e.g., in a multi-tenant database system 215) may be associated with data accessing unit 220-a and data accessing unit 220-b, where the different data accessing units 220 have different respective rules for data access. In some cases, the data accessing units 220-a and 220-b may share tenant data. In other cases, the data accessing units 220-a and 220-b may share a subset of tenant data, while refraining from sharing other tenant data. In yet other cases, the data accessing units 220-a and 220-b may be siloed and may not share any data between the data accessing units 220-a and 220-b. For example, the data accessing units 220-a and 220-b may be independent portions of an organization that do not share data with other portions of the organization. In an additional or alternative example, data associated with data accessing unit 220-a may be encrypted at rest, while data associated with data accessing unit 220-b may not be encrypted at rest. A tenant may be associated with any number of data accessing units 220, for example, based on a hierarchical structure of the tenant's organization. The specific rules for data access for each data accessing unit 220—which may be examples of BUs—may limit a tenant's ability to share data analytics, such as user segmentation, across organizational groups of the tenant. The rules may additionally or alternatively increase the processing overhead associated with data analytics, as the tenant may repeat processing resource-intensive data analysis in multiple different data accessing units 220.

To support publishing user segments to cross-channel activation endpoints (e.g., endpoints associated with different data accessing units 220), the system 200 may implement an activation target server 205. The activation target server 205 may create an activation target based on a user input. The activation target may include multiple data accessing units 220 (e.g., BUs) for a tenant of the database system 215. For example, each data accessing unit 220 may correspond to a separate, independent data stream (e.g., based on data storage policies of the data accessing units 220). The activation target may bundle segmentation and activation, such that a single segment may be duplicated, split, or a combination thereof between the separate data streams to allow for storage and processing of the segment in multiple different data accessing units 220. For example, the use of activation targets may support the publishing of a user segment to both data accessing unit 220-a and data accessing unit 220-b while preserving the data security policies of the data accessing units 220 (e.g., in one specific case, encrypting data associated with data accessing unit 220-a before storing the data and not encrypting data associated with data accessing unit 220-b before storing the data). The activation target may improve system efficiency by reducing redundant work across data accessing units 220. For example, the activation target may be associated with a custom-defined group, a combination of one or more BUs, personalization attributes, contact points, or any combination thereof. In some cases, users (e.g., marketers) may create a single object (e.g., an activation target) that may be used across multiple segments, thereby improving system efficiency and reducing redundant work.

In some cases, a user may utilize a pre-created activation target. For example, an activation target may be automatically generated based on the user's profile, activation targets previously utilized by the user, a machine-learned algorithm, or some combination thereof. In some additional or alternative cases, the user may create an activation target (e.g., on-the-fly) during the creation and publication procedure for a segment (e.g., a segment of users, groups of users, attributes, etc.). An activation target may improve a tenant's ability to measure the effectiveness of a publication or activation strategy across data accessing units 220. For example, an activation target may unify aspects of multiple different BUs within an organization and support the creation and tracking of metrics associated with the effectiveness of the publication or activation strategy across the BUs.

The database system 215 may ensure data security and improve data analysis techniques. In some cases, data associated with data accessing unit 220-a may be stored separately (e.g., logically separate, virtually separate, physically separate, etc.) from data associated with data accessing unit 220-b. For example, the database system 215 may restrict a user accessing data stored for data accessing unit 220-a from concurrently accessing data stored for data accessing unit 220-b. In another example, data associated with data accessing unit 220-a may be stored in an encrypted format, and the data may be encrypted using an encryption key that is associated with data accessing unit 220-a. A first group of users (e.g., users that are a part of data accessing unit 220-a, users that are associated with data accessing unit 220-a, etc.) may have access to the data associated with data accessing unit 220-a, and a second group of users (e.g., users that are a part of data accessing unit 220-b, users that are not associated with data accessing unit 220-a, etc.) may not have access to the data associated with data accessing unit 220-a. In some cases, the second group of users may not have access to the encryption key, so the data associated with data accessing unit 220-a may be protected from users who are not associated with data accessing unit 220-a. In some other cases, the second group of users may not have the proper login credentials or security credentials to access the data associated with data accessing unit 220-a.

In some cases, the database system 215 may store metadata (e.g., data lineage information, data history information, etc.), and the stored metadata may improve data analysis techniques. The metadata may indicate a history of the data (e.g., when the data was created, the user that created the data, the data accessing units 220 that have stored the data, any users that have accessed or modified the data, the origination location of the data, or any combination thereof). For example, if the database system 215 tracks the data lineage, each data object (e.g., associated with a user in a user segment) may include an indicator pointing to the originating data source for the data object (e.g., as metadata, as a data field, etc.). In some cases, the metadata or other data identifiers may be used to perform an analysis on the data stored at the database system 215. The metadata or other data identifiers may additionally or alternatively be used to measure or otherwise derive metrics associated with the data. In some cases, the activation target server 205 may determine a metric (e.g., a success metric, a response metric, an engagement metric, etc.) associated with an activation target based on metadata that is associated with the activation target and stored at the database system 215. In some cases, the metadata may be associated with multiple data accessing units 220, and the activation target server 205 may determine a metric that is associated with an individual data accessing unit 220, a group of data accessing units 220, an individual user segment, a group of user segments, or any combination thereof. The activation target server may improve data analysis techniques by supporting the analysis of metadata that is associated with one or more data accessing units 220, one or more user segments, or a combination thereof.

In some examples, the system 200 (e.g., the activation target server 205, database system 215, or both) may support evaluation of data sources, target users, user segments, or some combination thereof. For example, the system 200 may track the data lineage for users in user segments. The system 200 may assign a confidence level to each originating data source, which may be applicable to the user data records ingested from each originating data source. The confidence level values may be determined based on historical information, machine learning processes, user inputs, user feedback, or some combination thereof. For example, a data source providing user information based on data directly input by users (e.g., such as shipping information for a product) may have a higher confidence level than a data source providing user information scraped from a website and interpolated to determine projected users. The system 200 may process a user segment based on the confidence level information. For example, the system 200 may prioritize communications with users corresponding to originating sources with relatively higher confidence levels. In some examples, the confidence levels may be applicable across data accessing units 220 (e.g., based on the tenant allowing sharing of the confidence level information between the data accessing units 220). In some other examples, each data accessing unit 220 may store data accessing unit-specific confidence level information.

Similarly, the system 200 may analyze target users and user segments. For example, the system 200 may send messages to users based on a user segment and may receive information related to a response rate, a click rate, an open rate, or a combination thereof for the messages. This information may be used to rate different users in the segments, different user segments, different types of communications (e.g., whether email messages or text messages are more successful, etc.), or some combination thereof. Such ratings may support improved data analytics and user analysis to improve future messaging, marketing campaigns, or the like.

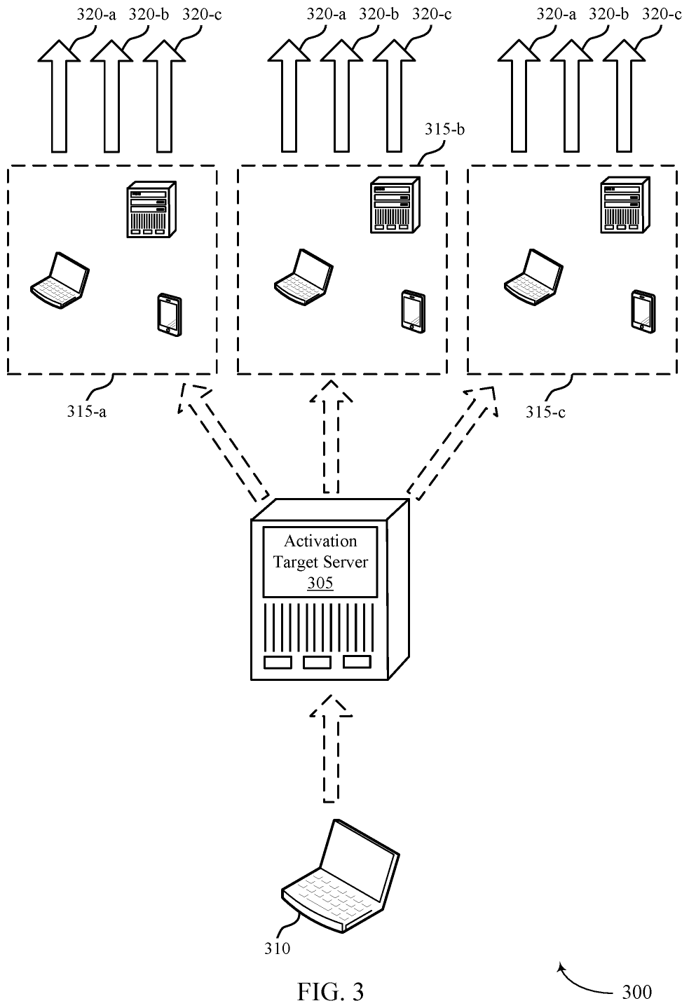

FIG. 3 illustrates an example of a user segment publication system 300 that supports creating and publishing user segments to cross-channel activation targets in accordance with aspects of the present disclosure. The user segment publication system 300 includes an activation target server 305, a number of user devices 310, and a number of user segments 315. The system 300 may implement aspects of a system 100 or 200 as described with reference to FIGS. 1 and 2. For example, an activation target server 305 may be an example or component of a data center 120 or an activation target server 205. A user device 310 may implement aspects of subsystem 125, a cloud client 105, or a user device 210.

An activation target server 305 may generate and/or define a user segment 315. In some cases, the activation target server 305 may generate a user segment 315 based on user segment traits or attributes indicated by a user device 310. For example, the activation target server 305 may generate user segment 315-a based on an indication of user information (e.g., user demographic information) associated with a target audience. In some cases, the activation target server 305 may define an activation target. For example, the activation target server may create an activation target based on one or more BUs, personalization attributes, or contact points (e.g., email addresses, mailing addresses, phone numbers, etc.). The activation target server 305 may publish one or more user segments to the activation target. For example, the activation target server 305 may publish user segment 315-a to a pre-defined activation target. In some additional or alternative examples, the activation target server 305 may publish user segment 315-a to an automatically generated activation target or a user-defined activation target.

In some cases, multiple user segments 315 may be published to an activation target. In some examples, the activation target server 305 may publish user segments 315-b and 315-c to the activation target, thereby improving system efficiency by not redefining the activation target or components of the activation target for user segments 315-b and 315-c. In some cases, a user associated with user device 310 may identify multiple activation targets to which user segment 315-a will be published, thereby preventing the user from redefining or recreating the user segment 315-a in multiple different data accessing units (e.g., across a single activation target or across multiple activation targets).

In some cases, system efficiency may be improved by publishing a user segment to multiple different activation targets. A user may define or indicate a set of user attributes, and a server (e.g., the activation target server 305) may generate the user segment based on the set of user attributes. Generating the user segment may be resource (e.g., time resources, computational resources, etc.) intensive, so generating a user segment once and publishing the user segment to multiple activation targets (e.g., with the same or different user attributes) may reduce system latency and increase resource availability.

For example, the activation target may support the activation target server 305 publishing user segment 315-a to multiple data accessing units. As illustrated, the activation target server 305 may publish user segment 315-a to three isolated data accessing units via data streams 320-a, 320-b, and 320-c. In some cases, the activation target server 305 may reuse the activation target to publish user segments 315-b and 315-c to the same data accessing units via the data streams 320-a, 320-b, and 320-c. While the activation target server 305 may perform a single segmentation process to determine the user segment 315-a, the activation target server 305 may send different values to the database system using different data streams 320. For example, a user may specify—according to a user input from user device 310—different attributes to store for the user segment 315-a in the different data accessing units. According to this information, the activation target server 305 may send different data and metadata on different data streams 320 into the database system. In a specific example, three data accessing units may be interested in users between the ages of twenty and thirty for different use cases. One data accessing unit may use email addresses to contact the users, one data accessing unit may use social media accounts to contact the users, and one data accessing unit may perform analysis on user likes and dislikes associated with email addresses. The activation target server 305 may generate a user segment based on the segmentation criteria or rule (e.g., based on the “age” data parameter for the users), where the user segment includes information related to email address identifiers, social media account identifiers, user like information, and user dislike information. When publishing the user segment to the relevant data accessing units, the activation target server 305 may send the same user identifiers included in the user segment to the database system via the data streams 320-a, 320-b, and 320-c. However, the activation target server 305 may additionally send the email address identifiers to the first data accessing unit via the data stream 320-a, the social media account identifiers to the second data accessing unit via the data stream 320-b, and the email address identifiers, the user like information, and the user dislike information to the third data accessing unit via the data stream 320-c.

In this way, the system 300 may efficiently customize attributes for a user segment across multiple data accessing units without performing multiple segmentations or activation procedures. Additionally, the system 300 may maintain the data isolation between the data accessing units to support data securitization procedures. For example, by maintaining separate data streams 320 to the separate data accessing units, the database system may maintain data storage and processing isolation between data accessing units. In some cases, a user accessing user segment 315-a stored in a first data accessing unit may not view, modify, or otherwise access the user segment 315-a—and associated parameters—stored in a second data accessing unit (e.g., if the user does not have the proper credentials for the second data accessing unit). According to hierarchical data sharing policies, the user also may not be able to view any data analytics or marketing uses for the user segment 315-a in the second data accessing unit (e.g., despite having access to the user segment 315-a and corresponding data analytics and marketing use cases separately stored for the first data accessing unit).

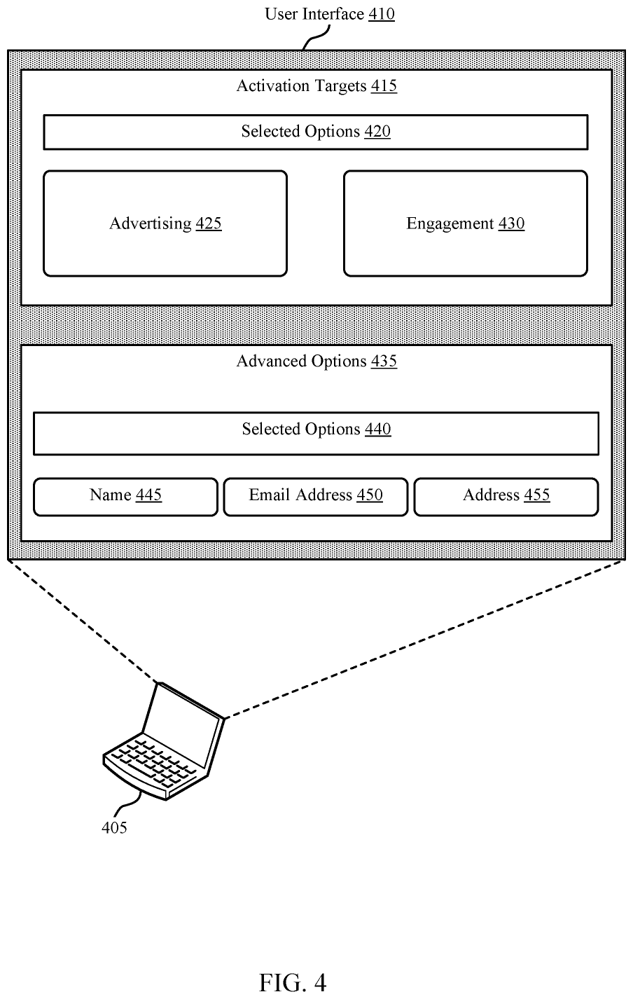

FIG. 4 illustrates an example of a user device 405 including a user interface 410 that supports creating and publishing user segments to cross-channel activation targets in accordance with aspects of the present disclosure. The user interface 410 may support a user (e.g., a user operating the user device 405) creating and publishing a user segment to an activation target 415 (e.g., across multiple siloed data accessing units). For example, the user interface 410 may provide a view for selecting an activation target 415 (e.g., advertising target 425, engagement target 430, etc.) and/or options 420 related to the activation target 415. In some cases, the option 420 may indicate the activation targets 415 that are selected.

The user interface 410 may support advanced options 435, such as the creation of a new activation target 415, among other advanced options 435. The selected options 440 may indicate attributes (e.g., name 445, email address 450, address 455, etc.) that are selected. The attributes may additionally or alternatively include age, gender, zip code, loyalty score, net worth, marital status, or any other attributes associated with users in a user segment. In some cases, the attributes may allow a user to specify how a user segment is packaged and sent to one or more data accessing units (e.g., a bundle of BUs). The user interface 410 may support the selection of an existing activation target 415, the creation of a new activation target 415, or both for publishing a user segment. Publishing a user segment may involve data-out storing of the user segment (e.g., to a data center, cloud-based storage, an end user or organization, etc.). Once a user segment is published, users with access to the user segment (e.g., based on the data accessing units for the users) may perform data analytics on the user segment, send messages to users in the user segment, or both.

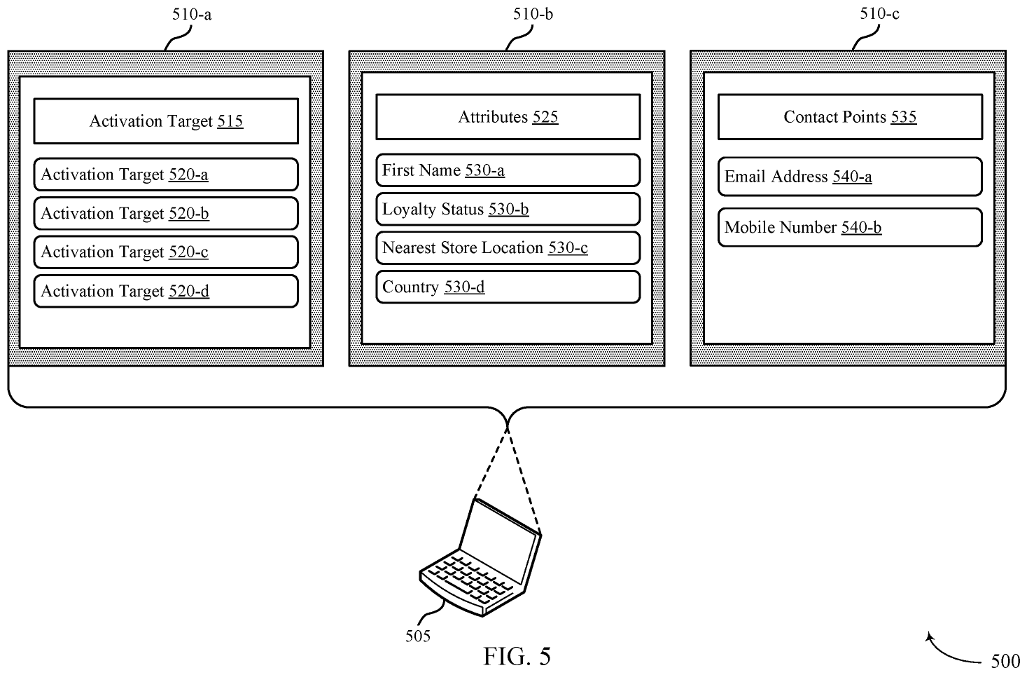

FIG. 5 illustrates an example of a user interface sequence 500 that supports creating and publishing user segments to cross-channel activation targets in accordance with aspects of the present disclosure. A user operating the user device 505 may progress through the user interface sequence 500 to create an activation target 515, customize attributes 525, customize contact points 535, or perform some combination of these functions. In some cases, the order of operations in the user interface sequence 500 may differ from the order illustrated. Furthermore, the user interface sequence 500 may support additional or alternative operations, user interfaces 510, or both.

The user interface sequence 500 may support selecting data accessing units (e.g., BUs) for an activation target 515, selecting attributes 525 for the activation target 515, and selecting contact points 535 for the activation target 515. The list of possible activation targets 520 may be defined by a user or automatically generated based on a data store or a tenant's organizational hierarchy. For example, user interface 510-a may include activation target 520-a, and activation target 520-a may be generated automatically. In some additional or alternative examples, activation target 520-b, activation target 520-c, and activation target 520-d may be generated based on a tenant's organizational hierarchy. For example, activation target 520-b may correspond to the tenant's corporate account, and activation target 520-c may correspond to a brand associated with the tenant. The user interface 510-a may display different activation targets 520 for different users, for example, based on user credentials, data accessing units with which the users are associated, or some combination thereof.

In some cases, user interface 510-b may support a user selecting a number of attributes 530 for the attributes 525. For example, the attribute “first name” 530-a may be selected by the user, and upon publishing a user segment to the activation target 515, “first name” 530-a may be used when contacting users of the user segment. In some examples, supporting the selection of user attributes may improve message (e.g., notification) personalization. Personalized messages may improve user experience and increase marketing effectiveness. Loyalty status 530-b, nearest store location 530-c, and country 530-d may be additional or alternative examples of attributes that may be included or otherwise incorporated into messages. The user interface 510-b may display any number of attributes 530 relevant for publishing a user segment, where, in some cases, the displayed attributes may be based on the user interacting with the user interface 510-b. In some examples, the user may select the same attributes 530 for each activation target 520 (e.g., data accessing unit or BU) or may select different attributes 530 for each activation target 520 (where particular targets may share particular attributes).

User interface 510-c may support a user selecting contact points 535. In some cases, the contact points 535 may indicate one or more means for contacting users of a user segment. For example, the contact point email address 540-a may indicate that users will be contacted via email, and email address 540-a may additionally indicate an email address, a type of email account, or both. The contact point mobile number 540-b may indicate a mobile phone number for contacting users of the user segment. The user interface 510-c may support any number of contact points 535 as options for contacting users in a segment.

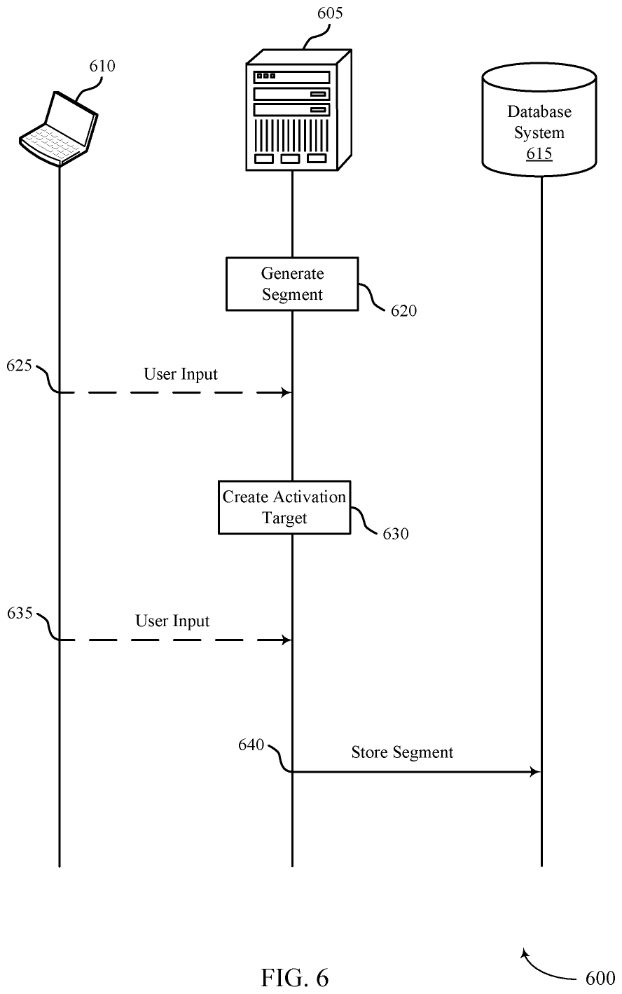

FIG. 6 illustrates an example of a process flow 600 that supports creating and publishing user segments to cross-channel activation targets in accordance with aspects of the present disclosure. The process flow 600 includes an activation target server 605, a user device 610, and a database system 615. These may be examples of the corresponding devices described with reference to FIGS. 1 through 5. For example, the activation target server 605 may serve a database system 615 (e.g., which may include a number of data accessing units, BUs, or the like) and may implement creating and publishing user segments to one or more activation targets. The activation target server 605 may increase available computational resources, support improved data analysis techniques, and improve user experience. Alternative examples of the following may be implemented, where some steps are performed in a different order than described or are not performed at all. In some cases, steps may include additional features not mentioned below, or further steps may be added.

At 620, the activation target server 605 may generate a user segment. In some cases, the user segment may be generated based on a segmentation rule. For example, the user segment may be generated based on users associated with a data accessing unit, a set of attributes, a defined user criteria, or the like.

At 625, the activation target server 605 may receive user input from a user device 610. For example, a user associated with the user device 610 may indicate a set of data accessing units of a total set of data accessing units for a tenant, and the activation target server 605 may receive the user input indicating the set of data accessing units. In some cases, each data accessing unit may include a respective subset of tenant users for the tenant and one or more data accessing unit-specific rules for data access by the respective subset of tenant users. For example, the data accessing unit-specific rules may be based on user preferences, a data management policy, a security policy, a regulation, a law, or the like.

At 630, the activation target server 605 may create an activation target, and the activation target may include the set of data accessing units. In some cases, the activation target may be created based on the first user input. For example, the activation target server 605 may receive the user input and create the activation target in response to receiving the first user input.

At 635, the activation target server 605 may receive a second user input from a user device 610. In some cases, the second user input and the first user input may be received from the same user device, while in other cases, the second user input and the first user input may be received from different user devices. The second user input may trigger the activation target server 605 to publish the generated segment to the activation target.

At 640, the activation target server 605 may store the user segment in the database system 615. In some cases, the activation target server 605 may store the user segment based on the second user input. The user segment may be accessible to tenant users of the set of data accessing units based on the activation target including the set of data accessing units. In some cases, the database system 615 may improve system security (e.g., by maintaining data isolation between different data accessing units). The database system 615 may be an example of a multi-tenant database system, where each tenant supported by the multi-tenant database system may include one or more data accessing units.

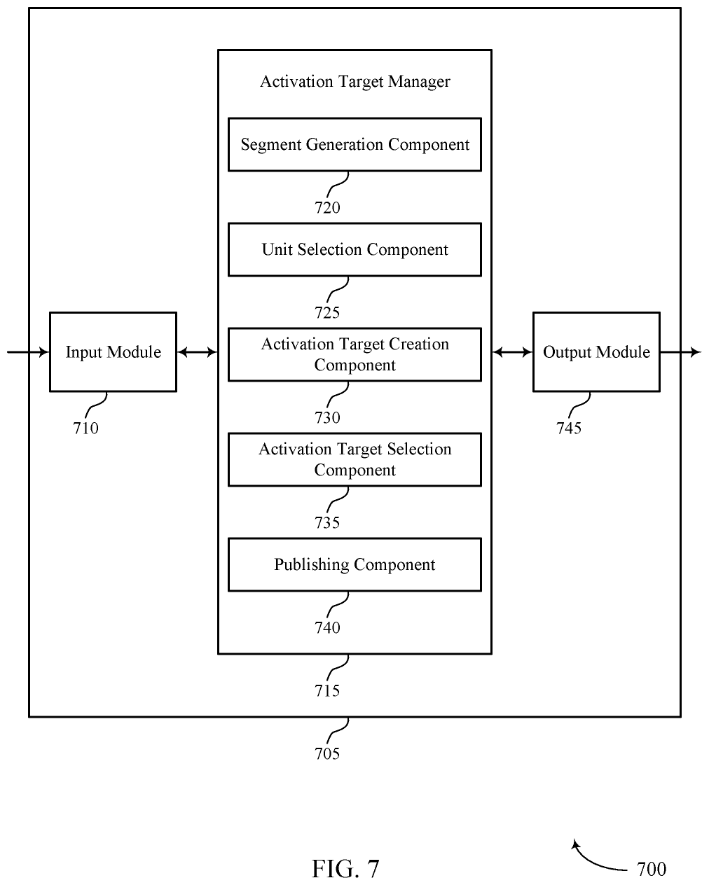

FIG. 7 shows a block diagram 700 of an apparatus 705 that supports creating and publishing user segments to cross-channel activation targets in accordance with aspects of the present disclosure. The apparatus 705 may include an input module 710, an activation target manager 715, and an output module 745. The apparatus 705 may also include a processor. Each of these components may be in communication with one another (e.g., via one or more buses). In some cases, the apparatus 705 may be an example of a user terminal, a server, or a system containing multiple computing devices. For example, the apparatus 705 may be an activation target server, which may be an example of a single server, a server cluster, an application server, a database server, a cloud-based server, a container, a virtual machine, a user device, or any other system or device supporting data processing.

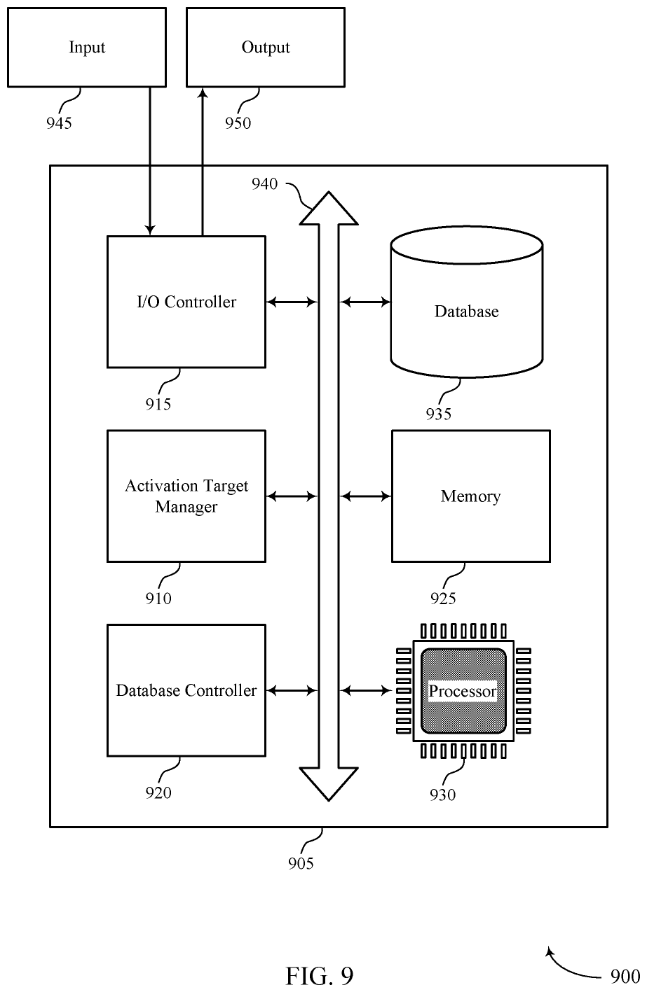

The input module 710 may manage input signals for the apparatus 705. For example, the input module 710 may identify input signals based on an interaction with a modem, a keyboard, a mouse, a touchscreen, or a similar device. These input signals may be associated with user input or processing at other components or devices. In some cases, the input module 710 may utilize an operating system such as iOS®, ANDROID®, MS-DOS®, MS-WINDOWS®, OS/2®, UNIX®, LINUX®, or another known operating system to handle input signals. The input module 710 may send aspects of these input signals to other components of the apparatus 705 for processing. For example, the input module 710 may transmit input signals to the activation target manager 715 to support creating and publishing user segments to cross-channel activation targets. In some cases, the input module 710 may be a component of an input/output (I/O) controller 915 as described with reference to FIG. 9.

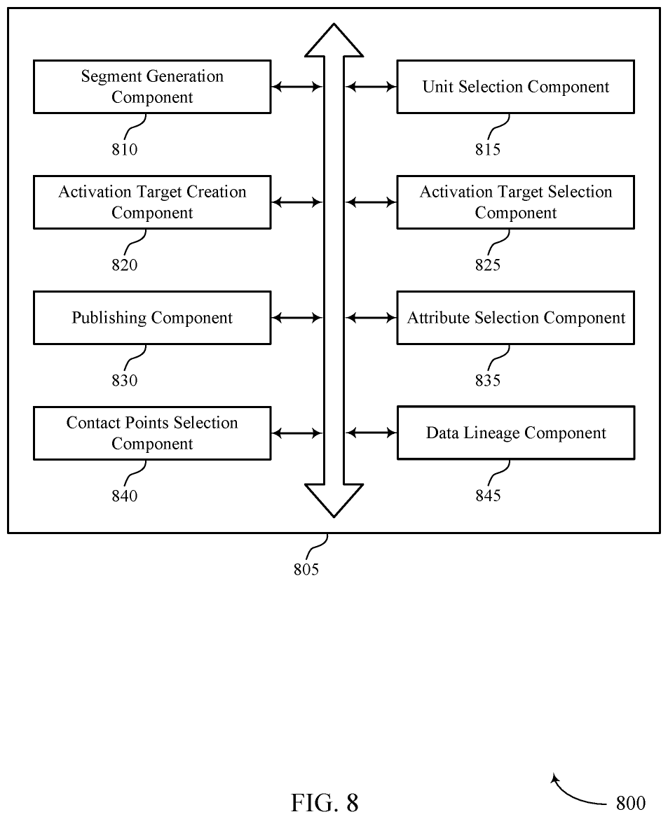

The activation target manager 715 may include a segment generation component 720, a unit selection component 725, an activation target creation component 730, an activation target selection component 735, and a publishing component 740. The activation target manager 715 may be an example of aspects of the activation target manager 805 or 910 described with reference to FIGS. 8 and 9.

The activation target manager 715 and/or at least some of its various sub-components may be implemented in hardware, software executed by a processor, firmware, or any combination thereof. If implemented in software executed by a processor, the functions of the activation target manager 715 and/or at least some of its various sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure. The activation target manager 715 and/or at least some of its various sub-components may be physically located at various positions, including being distributed such that portions of functions are implemented at different physical locations by one or more physical devices. In some examples, the activation target manager 715 and/or at least some of its various sub-components may be a separate and distinct component in accordance with various aspects of the present disclosure. In other examples, the activation target manager 715 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

The activation target manager 715 may manage data processing for a tenant of a database system. The segment generation component 720 may generate a segment of user identifiers from a set of user identifiers based on a segmentation rule. In some examples, the segment generation component 720 may additionally generate a second segment of user identifiers. In some cases, the second segment of user identifiers may be generated from a set of user identifiers based on a second segmentation rule.

The unit selection component 725 may receive a first user input indicating a set of data accessing units of a total set of data accessing units for the tenant, where each data accessing unit includes a respective subset of tenant users for the tenant and one or more data accessing unit-specific rules for data access by the respective subset of tenant users. The first user input may be received from a user device. The activation target creation component 730 may create an activation target including the set of data accessing units based on the first user input. One or more data accessing unit-specific rules may be based on a data protection rule, where the data protection rule may be based on the European Union's GDPR or any other data protection policy.

The activation target selection component 735 may receive a second user input indicating the activation target for publishing the segment. The second user input may be received from a user device (e.g., the same user device or a different user device). The publishing component 740 may store, at the database system, the segment based on the second user input, where the stored segment is accessible to tenant users of the set of data accessing units based on the activation target including the set of data accessing units. In some cases, this may involve the publishing component 740 publishing the segment to the activation target. In some cases, the publishing component 740 may additionally publish the second segment to the activation target. The publishing component 740 may additionally or alternatively transmit one or more messages to a group of user devices. In some cases, the messages may include or be otherwise associated with a text message, an email, a social media post, a push notification, or some combination thereof. The publishing component 740 may track a success metric based on transmitting the one or more messages and a response rate, a click rate, an open rate, or a combination thereof.

The output module 745 may manage output signals for the apparatus 705. For example, the output module 745 may receive signals from other components of the apparatus 705, such as the activation target manager 715, and may transmit these signals to other components or devices. In some specific examples, the output module 745 may transmit output signals for display in a user interface, for storage in a database or data store, for further processing at a server or server cluster, or for any other processes at any number of devices or systems. In some cases, the output module 745 may be a component of an I/O controller 915 as described with reference to FIG. 9.

FIG. 8 shows a block diagram 800 of an activation target manager 805 that supports creating and publishing user segments to cross-channel activation targets in accordance with aspects of the present disclosure. The activation target manager 805 may be an example of aspects of an activation target manager 715 or an activation target manager 910 described herein. The activation target manager 805 may include a segment generation component 810, a unit selection component 815, an activation target creation component 820, an activation target selection component 825, a publishing component 830, an attribute selection component 835, a contact points selection component 840, a data lineage component 845, or any combination of these or additional components. Each of these modules may communicate, directly or indirectly, with one another (e.g., via one or more buses). The activation target manager 805 may manage data processing for a tenant of a database system.

The segment generation component 810 may generate a segment of user identifiers from a set of user identifiers based on a segmentation rule. The segment may be generated at a server, an application server, communication server, data processing server, database server, cloud-based server, server cluster, virtual machine, container, or some similar data processing device or system. The unit selection component 815 may receive a first user input indicating a set of data accessing units of a total set of data accessing units for the tenant, where each data accessing unit includes a respective subset of tenant users for the tenant and one or more data accessing unit-specific rules for data access by the respective subset of tenant users.

The activation target creation component 820 may create an activation target including the set of data accessing units based on the first user input. The activation target may be created at a server, an application server, communication server, data processing server, database server, cloud-based server, server cluster, virtual machine, container, or some similar data processing device or system. The activation target selection component 825 may receive a second user input indicating the activation target for publishing the segment. The publishing component 830 may store, at the database system, the segment based on the second user input, where the stored segment is accessible to tenant users of the set of data accessing units based on the activation target including the set of data accessing units. In some cases, the total set of data accessing units includes the set of data accessing units and a second set of data accessing units, where the set of data accessing units is distinct from the second set of data accessing units. In some such cases, the stored segment is inaccessible to tenant users of the second set of data accessing units based on the activation target including the set of data accessing units distinct from the second set of data accessing units. In some cases, one or more data accessing units of the set of data accessing units may be associated with a business division or a business brand. One or more data accessing units of the set of data accessing units may additionally or alternatively be associated with a geographic region and/or a legal region.

In some cases, the set of user identifiers corresponds to a set of user data records. In some such cases, the attribute selection component 835 may receive, for the activation target, a third user input indicating a set of attributes of the user data records. The third user input may be received from a user device (e.g., the same or a different user device as the first user input, the second user input, or both). The attribute selection component 835 may store, at the database system, values for the set of attributes for each user data record corresponding to a user identifier of the segment, where the stored values are accessible to the tenant users of the set of data accessing units based on the third user input and the activation target including the set of data accessing units. The stored values may be accessible to a group of tenant users based on tenant user data accessing privileges associated with the group of tenant users, the set of data accessing units, or both. Additionally or alternatively, the stored values may be accessible to tenant users of the set of data accessing units based on a data security policy associated with the data accessing units or the tenant (e.g., a top-down data accessing policy applicable across multiple data accessing units for a tenant).

In some examples, the set of attributes may include a first subset of attributes of the user data records for a first subset of data accessing units of the set of data accessing units and a second subset of attributes of the user data records for a second subset of data accessing units of the set of data accessing units. In some such examples, the attribute selection component 835 may store, at the database system, a first set of values for the first subset of attributes for each user data record corresponding to a user identifier of the segment, where the stored first set of values is accessible to tenant users of the first subset of data accessing units based on the third user input and the activation target. Additionally, the attribute selection component 835 may store, at the database system, a second set of values for the second subset of attributes for each user data record corresponding to a user identifier of the segment, where the stored second set of values is accessible to tenant users of the second subset of data accessing units based on the third user input and the activation target. In some cases, the stored first set of values may be isolated from the stored second set of values at the database system based on the one or more data accessing unit-specific rules for data access for the set of data accessing units.

In some examples, the segment may be generated including the first set of values and the second set of values. In some such examples, storing the first set of values and storing the second set of values may involve the attribute selection component 835 splitting the generated segment into a first data stream and a second data stream. Splitting the segment may involve generating first metadata for a first set of data including the first set of values for the first subset of attributes for each user data record corresponding to a user identifier of the segment and generating second metadata for a second set of data including the second set of values for the second subset of attributes for each user data record corresponding to a user identifier of the segment. Splitting the segment may further involve sending, via the first data stream, the first set of data for storage in the database system according to the first subset of data accessing units and sending, via the second data stream, the second set of data for storage in the database system according to the second subset of data accessing units.

In some cases, the set of attributes may include a name, an email address, a phone number, or a combination of these or other contact points. For example, the contact points selection component 840 may store contact points for each user data record corresponding to a user identifier of the segment.

The data lineage component 845 may track a data lineage for the set of user data records. In some examples, storing the segment may involve the data lineage component 845 ingesting the set of user data records from one or more data sources and storing, at the database system, the set of user data records on the second user input, where each user data record of the set of user data records is stored with an indicator of a corresponding data source of the one or more data sources from which the user data record originates based on tracking the data lineage for the set of user data records. In some cases, the data lineage component 845 may store, in the database system, a confidence level associated with each data source of the one or more data sources and may process each user data record of the set of user data records based on the confidence level associated with the corresponding data source.

FIG. 9 shows a diagram of a system 900 including a device 905 that supports creating and publishing user segments to cross-channel activation targets in accordance with aspects of the present disclosure. The device 905 may be an example of or include the components of an application server or an apparatus 705 as described herein. The device 905 may include components for bi-directional data communications including components for transmitting and receiving communications, including an activation target manager 910, an I/O controller 915, a database controller 920, memory 925, a processor 930, and a database 935. These components may be in electronic communication via one or more buses (e.g., bus 940).

The activation target manager 910 may be an example of an activation target manager 715 or 805 as described herein. For example, the activation target manager 910 may perform any of the methods or processes described above with reference to FIGS. 7 and 8. In some cases, the activation target manager 910 may be implemented in hardware, software executed by a processor, firmware, or any combination thereof.

The I/O controller 915 may manage input signals 945 and output signals 950 for the device 905. The I/O controller 915 may also manage peripherals not integrated into the device 905. In some cases, the I/O controller 915 may represent a physical connection or port to an external peripheral. In some cases, the I/O controller 915 may utilize an operating system such as iOS®, ANDROID®, MS-DOS®, MS-WINDOWS®, OS/2®, UNIX®, LINUX®, or another known operating system. In other cases, the I/O controller 915 may represent or interact with a modem, a keyboard, a mouse, a touchscreen, or a similar device. In some cases, the I/O controller 915 may be implemented as part of a processor. In some cases, a user may interact with the device 905 via the I/O controller 915 or via hardware components controlled by the I/O controller 915.

The database controller 920 may manage data storage and processing in a database 935. In some cases, a user may interact with the database controller 920. In other cases, the database controller 920 may operate automatically without user interaction. The database 935 may be an example of a single database, a distributed database, multiple distributed databases, a data store, a data lake, or an emergency backup database.

Memory 925 may include random-access memory (RAM) and read-only memory (ROM). The memory 925 may store computer-readable, computer-executable software including instructions that, when executed, cause the processor to perform various functions described herein. In some cases, the memory 925 may contain, among other things, a basic I/O system (BIOS) which may control basic hardware or software operation such as the interaction with peripheral components or devices.

The processor 930 may include an intelligent hardware device (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 930 may be configured to operate a memory array using a memory controller. In other cases, a memory controller may be integrated into the processor 930. The processor 930 may be configured to execute computer-readable instructions stored in a memory 925 to perform various functions (e.g., functions or tasks supporting creating and publishing user segments to cross-channel activation targets).

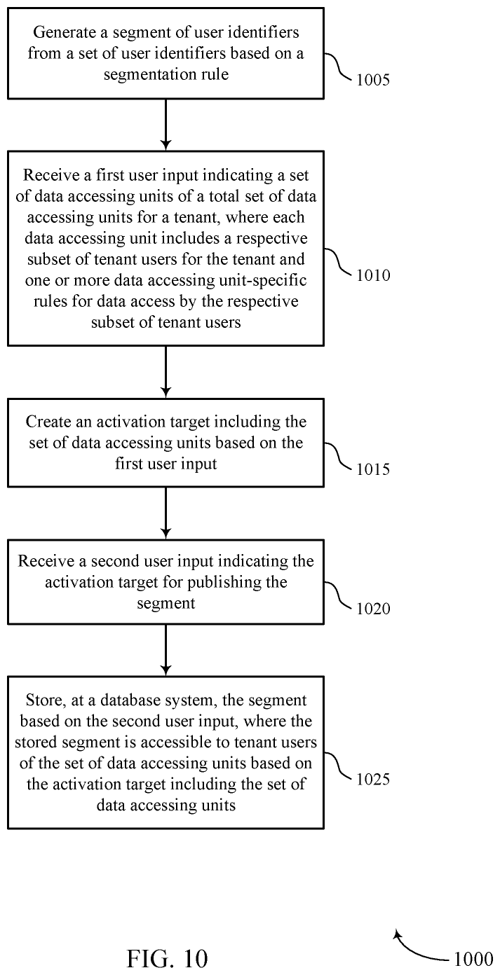

FIG. 10 shows a flowchart illustrating a method 1000 that supports creating and publishing user segments to cross-channel activation targets in accordance with aspects of the present disclosure. The operations of method 1000 may be implemented by an application server or its components as described herein. For example, the operations of method 1000 may be performed by an activation target manager as described with reference to FIGS. 7 through 9. In some examples, an application server may execute a set of instructions to control the functional elements of the application server to perform the functions described below. Additionally or alternatively, an application server may perform aspects of the functions described below using special-purpose hardware.

At 1005, the application server may generate a segment of user identifiers from a set of user identifiers based on a segmentation rule. The operations of 1005 may be performed according to the methods described herein. In some examples, aspects of the operations of 1005 may be performed by a segment generation component as described with reference to FIGS. 7 through 9.

At 1010, the application server may receive, from a user device, a first user input indicating a set of data accessing units of a total set of data accessing units for a tenant, where each data accessing unit includes a respective subset of tenant users for the tenant and one or more data accessing unit-specific rules for data access by the respective subset of tenant users. The operations of 1010 may be performed according to the methods described herein. In some examples, aspects of the operations of 1010 may be performed by a unit selection component as described with reference to FIGS. 7 through 9.

At 1015, the application server may create an activation target including the set of data accessing units based on the first user input. The operations of 1015 may be performed according to the methods described herein. In some examples, aspects of the operations of 1015 may be performed by an activation target creation component as described with reference to FIGS. 7 through 9.

At 1020, the application server may receive, from the user device, a second user input indicating the activation target for publishing the segment. The operations of 1020 may be performed according to the methods described herein. In some examples, aspects of the operations of 1020 may be performed by an activation target selection component as described with reference to FIGS. 7 through 9.

At 1025, the application server may store, at a database system, the segment based on the second user input, where the stored segment is accessible to tenant users of the set of data accessing units based on the activation target including the set of data accessing units. For example, the database system may store data and perform data processing in isolated environments to support tenant and data accessing unit security. The segment may be stored separately in each of the set of data accessing units at the database system (e.g., to support data storage and processing isolation between the data accessing units within the tenant environment). The operations of 1025 may be performed according to the methods described herein. In some examples, aspects of the operations of 1025 may be performed by a publishing component as described with reference to FIGS. 7 through 9.

A method for managing data processing for a tenant of a database system is described. The method may include generating, at an application server, a segment of user identifiers from a set of user identifiers based on a segmentation rule, receiving, from a user device, a first user input indicating a set of data accessing units of a total set of data accessing units for the tenant, where each data accessing unit includes a respective subset of tenant users for the tenant and one or more data accessing unit-specific rules for data access by the respective subset of tenant users, creating, at the application server, an activation target including the set of data accessing units based on the first user input, receiving, from the user device, a second user input indicating the activation target for publishing the segment, and storing, at the database system, the segment based on the second user input, where the stored segment is accessible to tenant users of the set of data accessing units based on the activation target including the set of data accessing units.

An apparatus for managing data processing for a tenant of a database system is described. The apparatus may include a processor, memory coupled with the processor, and instructions stored in the memory. The instructions may be executable by the processor to cause the apparatus to generate a segment of user identifiers from a set of user identifiers based on a segmentation rule, receive a first user input indicating a set of data accessing units of a total set of data accessing units for the tenant, where each data accessing unit includes a respective subset of tenant users for the tenant and one or more data accessing unit-specific rules for data access by the respective subset of tenant users, create an activation target including the set of data accessing units based on the first user input, receive a second user input indicating the activation target for publishing the segment, and store, at the database system, the segment based on the second user input, where the stored segment is accessible to tenant users of the set of data accessing units based on the activation target including the set of data accessing units.

Another apparatus for managing data processing for a tenant of a database system is described. The apparatus may include means for generating a segment of user identifiers from a set of user identifiers based on a segmentation rule, receiving a first user input indicating a set of data accessing units of a total set of data accessing units for the tenant, where each data accessing unit includes a respective subset of tenant users for the tenant and one or more data accessing unit-specific rules for data access by the respective subset of tenant users, creating an activation target including the set of data accessing units based on the first user input, receiving a second user input indicating the activation target for publishing the segment, and storing, at the database system, the segment based on the second user input, where the stored segment is accessible to tenant users of the set of data accessing units based on the activation target including the set of data accessing units.

A non-transitory computer-readable medium storing code for managing data processing for a tenant of a database system is described. The code may include instructions executable by a processor to generate a segment of user identifiers from a set of user identifiers based on a segmentation rule, receive a first user input indicating a set of data accessing units of a total set of data accessing units for the tenant, where each data accessing unit includes a respective subset of tenant users for the tenant and one or more data accessing unit-specific rules for data access by the respective subset of tenant users, create an activation target including the set of data accessing units based on the first user input, receive a second user input indicating the activation target for publishing the segment, and store, at the database system, the segment based on the second user input, where the stored segment is accessible to tenant users of the set of data accessing units based on the activation target including the set of data accessing units.

In some examples of the method, apparatuses, and non-transitory computer-readable medium described herein, the set of user identifiers corresponds to a set of user data records. Some examples of the method, apparatuses, and non-transitory computer-readable medium described herein may further include operations, features, means, or instructions for receiving, from the user device and for the activation target, a third user input indicating a set of attributes of the user data records and storing, at the database system, values for the set of attributes for each user data record corresponding to a user identifier of the segment, where the stored values are accessible to the tenant users of the set of data accessing units based on the third user input and the activation target including the set of data accessing units.

In some examples of the method, apparatuses, and non-transitory computer-readable medium described herein, the set of attributes includes a first subset of attributes of the user data records for a first subset of data accessing units of the set of data accessing units and a second subset of attributes of the user data records for a second subset of data accessing units of the set of data accessing units. Some examples of the method, apparatuses, and non-transitory computer-readable medium described herein may further include operations, features, means, or instructions for storing, at the database system, a first set of values for the first subset of attributes for each user data record corresponding to a user identifier of the segment, where the stored first set of values is accessible to tenant users of the first subset of data accessing units based on the third user input and the activation target and storing, at the database system, a second set of values for the second subset of attributes for each user data record corresponding to a user identifier of the segment, where the stored second set of values is accessible to tenant users of the second subset of data accessing units based on the third user input and the activation target.

In some examples of the method, apparatuses, and non-transitory computer-readable medium described herein, the segment may be generated including the first set of values and the second set of values. In some examples of the method, apparatuses, and non-transitory computer-readable medium described herein, storing the first set of values and storing the second set of values may further include operations, features, means, or instructions for splitting the generated segment into a first data stream and a second data stream. Furthermore, in some examples of the method, apparatuses, and non-transitory computer-readable medium described herein, the splitting may further include operations, features, means, or instructions for generating first metadata for a first set of data including the first set of values for the first subset of attributes for each user data record corresponding to a user identifier of the segment, generating second metadata for a second set of data including the second set of values for the second subset of attributes for each user data record corresponding to a user identifier of the segment, sending, via the first data stream, the first set of data for storage in the database system according to the first subset of data accessing units, and sending, via the second data stream, the second set of data for storage in the database system according to the second subset of data accessing units. In some examples of the method, apparatuses, and non-transitory computer-readable medium described herein, the stored first set of values is isolated from the stored second set of values at the database system based on the one or more data accessing unit-specific rules for data access for the set of data accessing units.

In some examples of the method, apparatuses, and non-transitory computer-readable medium described herein, the set of attributes includes a name, an email address, a phone number, or a combination thereof.

In some examples of the method, apparatuses, and non-transitory computer-readable medium described herein, the total set of data accessing units includes the set of data accessing units and a second set of data accessing units, the set of data accessing units is distinct from the second set of data accessing units, and the stored segment is inaccessible to tenant users of the second set of data accessing units based on the activation target including the set of data accessing units distinct from the second set of data accessing units.

In some examples of the method, apparatuses, and non-transitory computer-readable medium described herein, the set of user identifiers corresponds to a set of user data records and the method, apparatuses, and non-transitory computer-readable medium described herein may further include operations, features, means, or instructions for tracking a data lineage for the set of user data records.

In some examples of the method, apparatuses, and non-transitory computer-readable medium described herein, storing the segment may further include operations, features, means, or instructions for ingesting the set of user data records from one or more data sources and storing, at the database system, the set of user data records based on the second user input, where each user data record of the set of user data records is stored with an indicator of a corresponding data source of the one or more data sources from which the user data record originates based on tracking the data lineage for the set of user data records.

Some examples of the method, apparatuses, and non-transitory computer-readable medium described herein may further include operations, features, means, or instructions for storing, in the database system, a confidence level associated with each data source of the one or more data sources and processing each user data record of the set of user data records based on the confidence level associated with the corresponding data source.

In some examples of the method, apparatuses, and non-transitory computer-readable medium described herein, storing the segment may further include operations, features, means, or instructions for publishing, by the application server, the segment to the activation target. Some examples of the method, apparatuses, and non-transitory computer-readable medium described herein may further include operations, features, means, or instructions for generating, at the application server, a second segment of user identifiers from the set of user identifiers based on a second segmentation rule and publishing, by the application server, the second segment to the activation target.

Some examples of the method, apparatuses, and non-transitory computer-readable medium described herein may further include operations, features, means, or instructions for transmitting one or more messages to a set of user devices corresponding to the segment of user identifiers based on storing the segment at the database system, where the one or more messages include a text message, an email, a social media post, a push notification, or a combination thereof. Some examples of the method, apparatuses, and non-transitory computer-readable medium described herein may further include operations, features, means, or instructions for tracking, at the application server, a success metric based on transmitting the one or more messages and a response rate, a click rate, an open rate, or a combination thereof.

In some examples of the method, apparatuses, and non-transitory computer-readable medium described herein, the one or more data accessing unit-specific rules for data access include a data protection rule. In some examples of the method, apparatuses, and non-transitory computer-readable medium described herein, the data protection rule may be based on a GDPR.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for managing data processing for a tenant of a database system, comprising:
generating, at an application server, a segment of user identifiers from a plurality of user identifiers based at least in part on a segmentation rule;
receiving, from a user device, a first user input indicating a plurality of data accessing units of a total set of data accessing units for the tenant, wherein each data accessing unit comprises a respective subset of tenant users for the tenant and one or more data accessing unit-specific rules for data access by the respective subset of tenant users;
creating, at the application server, an activation target comprising the plurality of data accessing units based at least in part on the first user input;
receiving, from the user device a second user input indicating the activation target for publishing the segment; and
storing, at the database system, the segment based at least in part on the second user input, wherein the stored segment is accessible to tenant users of the plurality of data accessing units based at least in part on the activation target comprising the plurality of data accessing units.

2. The method of claim 1, wherein the plurality of user identifiers corresponds to a plurality of user data records, the method further comprising:
receiving, from the user device and for the activation target, a third user input indicating a set of attributes of the user data records; and
storing, at the database system, values for the set of attributes for each user data record corresponding to a user identifier of the segment, wherein the stored values are accessible to the tenant users of the plurality of data accessing units based at least in part on the third user input and the activation target comprising the plurality of data accessing units.

3. The method of claim 2, wherein the set of attributes comprises a first subset of attributes of the user data records for a first subset of data accessing units of the plurality of data accessing units and a second subset of attributes of the user data records for a second subset of data accessing units of the plurality of data accessing units, and wherein storing the values for the set of attributes comprises:
storing, at the database system, a first set of values for the first subset of attributes for each user data record corresponding to a user identifier of the segment, wherein the stored first set of values is accessible to tenant users of the first subset of data accessing units based at least in part on the third user input and the activation target; and
storing, at the database system, a second set of values for the second subset of attributes for each user data record corresponding to a user identifier of the segment, wherein the stored second set of values is accessible to tenant users of the second subset of data accessing units based at least in part on the third user input and the activation target.

4. The method of claim 3, wherein the segment is generated comprising the first set of values and the second set of values and wherein storing the first set of values and storing the second set of values further comprises:
splitting the generated segment into a first data stream and a second data stream, wherein the splitting comprises:
generating first metadata for a first set of data comprising the first set of values for the first subset of attributes for each user data record corresponding to a user identifier of the segment;
generating second metadata for a second set of data comprising the second set of values for the second subset of attributes for each user data record corresponding to a user identifier of the segment;
sending, via the first data stream, the first set of data for storage in the database system according to the first subset of data accessing units; and
sending, via the second data stream, the second set of data for storage in the database system according to the second subset of data accessing units.

5. The method of claim 3, wherein the stored first set of values is isolated from the stored second set of values at the database system based at least in part on the one or more data accessing unit-specific rules for data access for the plurality of data accessing units.

6. The method of claim 2, wherein the set of attributes comprises a name, an email address, a phone number, or a combination thereof.

7. The method of claim 1, wherein:
the total set of data accessing units comprises the plurality of data accessing units and a second plurality of data accessing units;
the plurality of data accessing units is distinct from the second plurality of data accessing units; and
the stored segment is inaccessible to tenant users of the second plurality of data accessing units based at least in part on the activation target comprising the plurality of data accessing units distinct from the second plurality of data accessing units.

8. The method of claim 1, wherein the plurality of user identifiers corresponds to a plurality of user data records, the method further comprising:
tracking a data lineage for the plurality of user data records.

9. The method of claim 8, wherein storing the segment further comprises:
ingesting the plurality of user data records from one or more data sources; and
storing, at the database system, the plurality of user data records based at least in part on the second user input, wherein each user data record of the plurality of user data records is stored with an indicator of a corresponding data source of the one or more data sources from which the user data record originates based at least in part on tracking the data lineage for the plurality of user data records.

10. The method of claim 9, further comprising:
storing, in the database system, a confidence level associated with each data source of the one or more data sources; and
processing each user data record of the plurality of user data records based at least in part on the confidence level associated with the corresponding data source.

11. The method of claim 1, wherein the storing comprises:
publishing, by the application server, the segment to the activation target.

12. The method of claim 11, further comprising:
generating, at the application server, a second segment of user identifiers from the plurality of user identifiers based at least in part on a second segmentation rule; and
publishing, by the application server, the second segment to the activation target.

13. The method of claim 1, further comprising:
transmitting one or more messages to a plurality of user devices corresponding to the segment of user identifiers based at least in part on storing the segment at the database system, wherein the one or more messages comprise a text message, an email, a social media post, a push notification, or a combination thereof.

14. The method of claim 13, further comprising:
tracking, at the application server, a success metric based at least in part on transmitting the one or more messages and a response rate, a click rate, an open rate, or a combination thereof.

15. The method of claim 1, wherein the one or more data accessing unit-specific rules for data access comprise a data protection rule.

16. The method of claim 15, wherein the data protection rule is based at least in part on a general data protection regulation (GDPR).

17. An apparatus for managing data processing for a tenant of a database system, comprising:
a processor;
memory coupled with the processor; and
instructions stored in the memory and executable by the processor to cause the apparatus to:
generate a segment of user identifiers from a plurality of user identifiers based at least in part on a segmentation rule;
receive a first user input indicating a plurality of data accessing units of a total set of data accessing units for the tenant, wherein each data accessing unit comprises a respective subset of tenant users for the tenant and one or more data accessing unit-specific rules for data access by the respective subset of tenant users;
create an activation target comprising the plurality of data accessing units based at least in part on the first user input;
receive a second user input indicating the activation target for publishing the segment; and
store, at the database system, the segment based at least in part on the second user input, wherein the stored segment is accessible to tenant users of the plurality of data accessing units based at least in part on the activation target comprising the plurality of data accessing units.

18. The method of claim 17, wherein the plurality of user identifiers corresponds to a plurality of user data records, the instructions further executable by the processor to cause the apparatus to:
receive, from the user device and for the activation target, a third user input indicating a set of attributes of the user data records; and
store, at the database system, values for the set of attributes for each user data record corresponding to a user identifier of the segment, wherein the stored values are accessible to the tenant users of the plurality of data accessing units based at least in part on the third user input and the activation target comprising the plurality of data accessing units.

19. The method of claim 17, wherein:
the total set of data accessing units comprises the plurality of data accessing units and a second plurality of data accessing units;
the plurality of data accessing units is distinct from the second plurality of data accessing units; and
the stored segment is inaccessible to tenant users of the second plurality of data accessing units based at least in part on the activation target comprising the plurality of data accessing units distinct from the second plurality of data accessing units.

20. A non-transitory computer-readable medium storing code for managing data processing for a tenant of a database system, the code comprising instructions executable by a processor to:
generate a segment of user identifiers from a plurality of user identifiers based at least in part on a segmentation rule;
receive a first user input indicating a plurality of data accessing units of a total set of data accessing units for the tenant, wherein each data accessing unit comprises a respective subset of tenant users for the tenant and one or more data accessing unit-specific rules for data access by the respective subset of tenant users;
create an activation target comprising the plurality of data accessing units based at least in part on the first user input;
receive a second user input indicating the activation target for publishing the segment; and
store, at the database system, the segment based at least in part on the second user input, wherein the stored segment is accessible to tenant users of the plurality of data accessing units based at least in part on the activation target comprising the plurality of data accessing units.
